(19) United States
(12) Patent Application Publication
(10) Pub. No.: US 2012/0166345 A1
(43) Pub. Date: Jun. 28, 2012

(54) SYSTEM AND METHOD FOR PERSONALIZED CUSTOMER SERVICE OBJECTS IN CONTACT CENTERS

(75) Inventor: Reinhard Klemm, Basking Ridge, NJ (US)

(73) Assignee: Avaya Inc., Basking Ridge, NJ (US)

(21) Appl. No.: 12/978,904

(22) Filed: Dec. 27, 2010

(51) Int. Cl. G06Q 10/00

(52) U.S. Cl. 705/304

(57) ABSTRACT

Disclosed herein are systems, methods, and non-transitory computer-readable storage media for providing customized customer service interactions between users and an enterprise. A method includes the steps of receiving a customer service request from a user terminal and generating a customer intimacy profile for the user associated with the user terminal based at least on user data associated with the user and available from at least one social media channel. The method also includes assembling customer service object for the user terminal based at least on the customer intimacy profile, where the customer service object identifying at least one customer service channel available for the user. The method further includes delivering a user interface to the user terminal, where a content of the user interface is based on the customer service object.

### BACKGROUND

1. Technical Field

The present disclosure relates to remote customer service systems and more specifically to systems and method for providing customized remote customer service.

2. Introduction

Remote customer service, rendered by a contact center through telephony, email, chat, or Internet interfaces tends to disregard the personas, preferences, characteristics, opinions, inclinations, idiosyncrasies, circumstances, situations, and tastes of customers. That is, the “personal touch” that a customer typically experiences when visiting a store where he or she is familiar to store representatives is lost because remote contact centers generally have very limited, if any, knowledge of the personal details of customers. Further, relationships can be difficult to establish in remote contact centers because there is often little or no personal continuity across multiple interactions. In other words, each time a customer calls in, they are typically connected to a different contact center agent. This total lack of knowledge can result in customer disloyalty and dissatisfaction, leading to ineffectiveness and higher operating costs for the contact center and loss of revenue generating or cost reduction opportunities for an enterprise.

A conventional remote customer contact center typically provides its agents with customer data that the enterprise or contact center has previously collected from or about the customer during various types of customer/enterprise interactions. However, because this customer data is limited to customer interactions, such as purchases, the data necessary for providing a personalization of the customer service experience is generally unavailable to agents. Even worse, no customer data is generally available for new customers or customers contacting the customer contact center a first time.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein are systems, methods, and non-transitory computer-readable storage media for providing customized customer service interactions between users and an enterprise. A system configured to practice the method is configured for receiving a customer service request from a user terminal. The system is also configured for generating a customer intimacy profile for the user associated with the user terminal based at least on user data associated with the user and available from at least one social media channel. Thereafter, the system can assemble a customer service object for the user terminal based at least on the customer intimacy profile, where the customer service object identifies at least one customer service channel available for the user. Based on the assembled customer service object, the system can then delivering a user interface to the user terminal, where the content of the user interface is based on the customer service object.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary architecture in which the various embodiments can be implemented;

FIG. 3 illustrates an first exemplary interface for a direct social media channel associated with an enterprise according to an embodiment;

FIG. 4 illustrates a second exemplary interface for a direct social media channel associated with an enterprise according to an embodiment;

FIG. 5 illustrates an exemplary customer service object for a user according to an embodiment;

FIG. 6 illustrates an exemplary customer service object for an agent of the enterprise according to an embodiment; and

FIG. 7 illustrates an exemplary method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

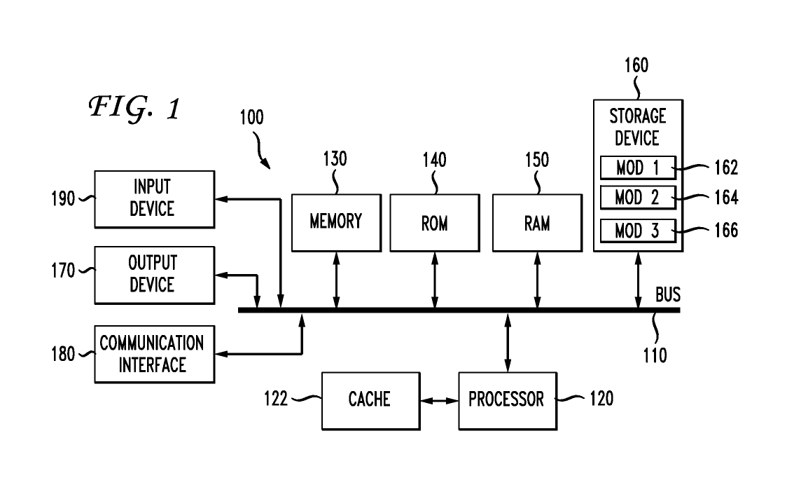

The present disclosure addresses the need in the art for personalizing customer service in contact centers. A system, method and non-transitory computer-readable media are disclosed which a personalized customer service client is generated in contact center. A brief introductory description of a basic general purpose system or computing device in FIG. 1 which can be employed to practice the concepts is disclosed herein. A more detailed description of the operating environment and the personalized customer service client will then follow.

As noted above, when rendering remote customer service regarding products, the traditional contact center software of an enterpise typically attempts to access customer data that the enterprise or contact center has previously collected from or about the customer during various types of customer/enterprise interactions. However, such enterprise-internal data generally limits possible inferences about the customer's persona, preferences, characteristics, opinions, inclinations, idiosyncrasies, circumstances, situations, and tastes. Consequently, the data enables only very limited personalization of customer service (agent selection, customer service options, language selection, self service content, revenue generating or cost reduction opportunities, etc.).

In view of the foregoing, the various embodiments provide systems and methods for Personalized Customer Service Objects (CSOs) for rendering highly personalized remote customer service. In particular, these CSOs are software objects used to implement and/or manage the remote customer service experience, where the CSOs are generated based on personal data available from one or more data sources. In operation, when customer service is requested by a user, a server identifies the user, generates a customer intimacy profile characterizing the user based on internal and/or external data sources, and tailors the CSO and the remote customer service experience based on the customer intimacy profile. In some embodiments, the CSO itself is the user interface or widget provided to a user. Accordingly, a CSO can include audio elements, visual elements, or any combination thereof, depending on the communications channel being used by the user. Variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

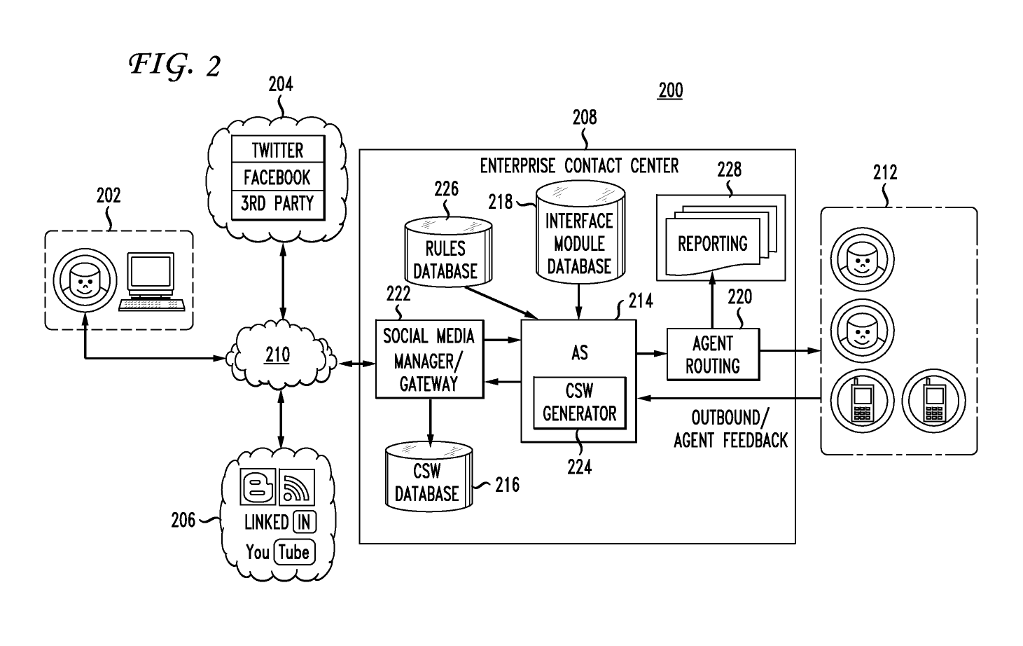

Having disclosed some components of a computing system, the disclosure now turns to FIG. 2, which illustrates an exemplary architecture 200 in which the various embodiments can be implemented. As shown in FIG. 2, the exemplary architecture 200 includes user terminals 202 associated with users, direct social media channels 204 (with respect to the enterprise), indirect social media channels 206 (with respect to the enterprise), and an enterprise contact center (ECC) system 208 of an enterprise. The elements 202-208 can be connected via at least one network 210.

In the various embodiments, the ECC system 208 can be configured to support a variety of communications modes. For example, ECC system 208 can be configured to support real-time communication modes. That is, communication modes which are “live” or in which there is no appreciable latency between user and agent communication. Such communications modes can include telephony communications (land-line and mobile), instant messaging, internet relay chat (IRC) or other chatting modes, videoconference, teleconference, or tele-presence, to name a few. However, the various embodiments are not limited in this regard and any other type of real-time communications mode can also be used.

Alternatively, or in combination with real-time communications modes, the ECC system 208 can also be configured to support time-shifted communications modes. That is, communications modes in which messages between users and agents are stored at some intermediate point. For example, such communications modes can include email, electronic message boards, social networks, or any other communications mode in which messages from the agent to the user or the user to the agent are stored at some intermediate point, allowing the recipient to access the messages without the need to maintain an active communications link with the sender.

The ECC system 208 can be configured to support the communication modes described above using a wide variety of devices for user terminals 202, including devices operating over analog or digital communication channels designed for the delivery of information to users in an audio form, a visual form (including static and dynamic visual elements), or any combination thereof. For example, in some embodiments, the ECC system can be configured to support user terminals consisting of a general purpose computer device connected to a data network, as described above with respect to FIG. 1. Such devices can include a desktop computer, portable computer, personal digital assistant, smartphone, or any other type of appliance or device having access to one or more data networks supporting real-time and/or time-shifted communication modes over such networks. However, the various embodiments are not limited in this regard. For example the user terminals 202 can be devices supporting real-time and/or time-shifted communications over telephony networks or any other type of communications networks. Such devices include land-line telephone devices, mobile or cellular telephone devices, videophone devices, and the like. However, the various embodiments are not limited in this regard and any other types of devices can be used for user terminals 202.

Additionally, the architecture 200 can include agent terminals 212 associated with agents of the enterprise and configured for providing customer service to users at the user terminals 202. In particular, ECC system 208 connects and manages the communication link or session between user terminals 202 and agent terminals 212. Although the agent terminals 212 are shown in FIG. 2 as being connected to network 210 via ECC system 208, the various embodiments are not limited in this regard. Rather, in some embodiments, one or more of the agent terminals 212 can be directly connected to network 210 and can communicate with ECC system 208 via network 210. The agent terminals 212, like the user terminals 202 can be configured to support real-time and/or time-shifted communications modes. Accordingly, the description above regarding the communications modes and devices for user terminals 202 is equally applicable to agent terminals 212.

As shown in FIG. 2, social media channels 204 and 206 are accessible through network 210 and consist of direct and indirect social media channels, respectively, with respect to the enterprise. As used herein, a “direct” social media channel refers to a social media channel that is directly related or associated with the enterprise. For example, the social media channel can be a publically accessible communications channel that is managed and controlled by the customer care center of the enterprise, such as a customer support user forum established and managed by the enterprise. However, in the various embodiments, such direct social media channels can also include online communications channels which are partially managed or controlled by the enterprise. For example, a Facebook® or Twitter® site or page established by the enterprise. However, the various embodiments are not limited to the examples above and a direct social media channel can include any other type of communications channel in which the content is at least partially managed or controlled by the enterprise.

In contrast, an “indirect” social media channel refers to a social media channel in which the enterprise is a participant and is not involved in the management, establishment, or control thereof. Such indirect social media channels can include channels that are viewable by the general public, including channels requiring registration or having some type of authentication procedures for accessing the channel. For example, a blog or other online communications channel established by one or more customers of the enterprise. In such a communication channel, the enterprise can monitor and interact with customers, but others can control the content in the communications channel. However, the various embodiments are not limited to the examples above and an indirect social media channel can include any other type of communications channel in which the enterprise does not have control of the content posted thereon.

ECC system 208 generally operates as follows. First, a user terminal 202 can generate a request for customer service that is received by the ECC system 208. Second, the ECC system 208 then identifies the user and user terminal type associated with the request. Such an identification can be made based on the type of communications mode or device associated with the request and information stored in the ECC system 208 regarding different users. Third, based on the identification of the user, the user terminal 202, and a customer intimacy profile associated with the user, a CSO can be generated can be generated by the ECC system 208. Finally, the ECC system 208 can deploy the CSO in order to guide the user to an agent of the enterprise which can address their issue.

As user herein, the term “customer intimacy profile” refers to the set of user data that is used by the enterprise to characterize a user. Such user data can include biographical user data, demographic user data, and external or internal behavioral user data, to name a few. The behavioral data can include the user's history with respect to the enterprise and/or any other entity or social media channel. However, a customer intimacy profile is not limited in this regard and can include any other type of user data used by the enterprise to characterize or classify users. Further, the user data for the customer intimacy profile is not limited to user data collected during an interaction between a user and the enterprise, but can include any other user data collected from one or more sources external to the enterprise. Additionally, the customer intimacy profile can be raw user data or processed user data. That is, the user data can be analyzed to characterize the user and thereafter construct the customer intimacy profile. For example, the customer intimacy profile can be a set of values associated with a user and a set of characteristics, where the values are selected based on the user data obtained. However, the disclosure is not limited in this regard and any other methods for evaluating user data to generate a profile can be used without limitation.

In the various embodiments, the user data for the customer intimacy profile is obtained in several ways and from several sources. A primary source of user data can be the enterprise itself That is, the enterprise can store information regarding the user, products purchased by the user, and a history of the user's interactions with the enterprise. However, when the customer intimacy profile based only on such limited data, the customer intimacy profile will provide only a limited view of the overall characteristics of the user, specifically the characteristics of the user with respect to the enterprise.

Accordingly, in the various embodiments, a secondary source of user data is utilized, social media channels. In particular, the ECC system 208 is configured to access and monitor social media channels 204, 206 for user data. Such social media channels can include direct or indirect social media channels, as described above, and social media channels associated with a same or a different domain as compared to the domain of the enterprise. As a result, the user data collected, and consequently the resulting customer intimacy profile, will reflect additional aspects of the user. Thus, the customer intimacy profile, and the thus the CSO, will more accurately reflect the overall characteristics of the user and allows the enterprise to provide more personalized service.

In the various embodiments, the user terminals 202 and the ECC system 208 can communicate in various ways. In some embodiments, the user utilizes the user terminal 202 to establish a real-time communication session with the enterprise. Thereafter, the ECC system 208 generates a CSO, based on the customer intimacy profile, to guide the user during the real-time communication session to cause an agent to be joined to the communications session and provide customer service to the user. For example, the user can establish a telephony communications link with the enterprise. The ECC system 208 can then generate the CSO in the form of an interactive menu to guide the user to an agent and join the agent to the real-time communications session. A similar experience can be provided for users establishing a communication session with the enterprise over a videophone, instant messaging, or other real-time communications means. In the case of instant messaging communications means and the like, the CSO can be in the form of an application that generates questions for the user and provides answers and information to guide the user to an agent based on an analysis of the content of the user's inputs.

In some embodiments, the user utilizes the user terminal 202 to establish a time-shifted communication session with the enterprise. Thereafter, the ECC system 208 generates a CSO, based on the customer intimacy profile, to guide the user to establish a time-shifted communication session with a user agent. For example, the CSO can lead the user to an email address, an electronic bulletin board, or other time-shifted communications means to obtain customer service.

In still other embodiments, one or more time-shifted communications can first occur, followed by a real-time communication session between the user and the agent. For example, a user can utilize user terminal 202 to indicate their desire to establish a communications session with an agent of the enterprise. Such an indication can be by way of providing a message or post on a social media, by sending an email to the enterprise, or providing the indication via any other type of time-shifted communication means. The ECC system 208 can receive such an indication and generate a CSO for the user based on the customer intimacy profile. Thereafter, the ECC system 208 can deliver the CSO to the user directly or the CSO can be used to generate instructions for establishing the real-time communications session or instructions for doing so. Finally, the user can establish the real-time communications session.

To provide the functionality described above, the ECC system 208 in FIG. 2 includes an application server (AS) 214, a customer relationship management database (CRM DB) 216, a interface module database (interface module DB) 218, an agent routing module 220, a social media manager/gateway (SMMG) module 222, a reporting module 228, and a rules database (rules DB) 226.

In the exemplary architecture, to the ECC system 208 for the user terminals 202 and agent terminals 212 is provided by the SMMG module 222 and agent routing module 220, respectively.

The SMMG module 222 can operate as a gateway node to allow user terminals 202 to communicate and access the ECC system 208 in accordance with conventional gateway systems and method. However, in addition to providing gateway services, the SMMG module 222 also provides additional functionality.

First, the SMMG module 222 can operate as a data aggregator collecting information regarding the users' interactions from social media channels 204 and 206. Such aggregation can be provided in several ways. For example, the SMMG module 222 can include a data collection or aggregation engine to perform the aggregation itself. Alternatively or in combination with such an aggregation engine, the SMMG module 222 can be configured to operate with other modules, internal or external to ECC system 208, configured for collecting data regarding users. For example, the SMMG module 22 can be configured to operate with a third party aggregator system (not shown) connected to network 210.

Second, the SMMG module 222 can be used to at least partially analyze the collected information. For example, the SMMG module 222 can include a data analysis engine to identify spam or irrelevant information with respect to generating a customer intimacy profile, to rank the information according to a relevance to a particular subject or other criteria, or to classify information according to subject, topic, user, product, and/or any other classification scheme. The SMMG module 222 can also be configured to store the final, relevant user information in CRM database 216 for use by AS 214. For example, the SMMG module 222 can be configured to generate the customer intimacy profile and store it in CRM database 216.

As also shown in architecture 200, the connection between user terminals 202 and agent terminals 212 is provided via the agent routing module 220. In response to a user at the user terminal 202 selecting a particular contact option provided in the CSO, the agent routing module 220 establishes the communications link associated with the selected contact option in the CSO between the user terminal 202 and the agent terminal 212.

Although the SMMG module 222 and the agent routing module 220 are show as separate entities, the various embodiments are not limited in this regard. In some configuration, a single module can be used to implement the functionality of both the SMMG module 222 and the agent routing module 220.

As described above, the ECC system 208 also includes AS 214 for assembling and deploying the CSOs for the terminals 202 and 212. In particular, AS 214 includes a CSO generator 224 for assembling the CSO's based on the customer intimacy profile stored in CRM database 216, pre-built interface modules stored in interface module database 218, and rules from rule DB 226. In operation, responsive to a request for customer service from a user terminal 202, the CSO generator 224 generates a CSO and the AS 214 deploy the CSO, resulting in delivery of a customized user interface to a user terminal associated with the user.

In particular, the CSO generator 224 retrieves the customer intimacy profile associated with the user from CRM database 216 and the rules from rules DB 226. The rules and the customer intimacy profile can then be used to select the interface modules from interface module database 218 that are appropriate for the user and the user terminal 202. Thereafter, the CSO generator 224 assembles the CSO. Thereafter, a user interface, based on the CSO, can be delivered to the user terminal 202. For example the CSO can be delivered to the user terminal or the CSO is used by ECC system 208 to manage interactions with the user terminal 202.

In the various embodiments, the rules DB 226 can include various types of rules established by the enterprise for generating CSOs. For example, the rules can indicate which interface modules from interface module DB 218 to include for a CSO based on the type of user interface associated with the user and/or the characteristics of the customer intimacy profile associated with the user. In another example, the rules database can indicate which information to include in CSO, and thus in the user interface, based on the type of user terminal associated with the user and/or the characteristics of the customer intimacy profile associated with the user. Additionally, the rules DB 226 can specify the various characteristics for classifying or categorizing users or user terminals.

The rules in rules DB 226 can be updated to account for changes in the enterprise, users, or social media channels. These changes can be provided in a variety of ways. For example, a reporting engine 228 monitoring the agent routing module 220 can generate data indicating changes that are needed to be made to improve customer service for one or more types of users or one or more types of user terminals. Further, as noted below, an agent can supply additional information regarding users and their experiences during their customer service interactions. Other sources of data are also possible. Regardless of the source of this updated data, the rules in rules DB 226 can then be changed to accommodate such changes. In some embodiments, these changes can be made automatically. For example, the ECC system 208 can include a rule updating engine (not shown) that analyzes such data and automatically updates rules. However, the various embodiments are not limited in this regard and such a rules updating engine can be located elsewhere. Further, the rules can also be manually updated.

In some embodiments, the rules in the rules DB 226 can be configured to utilize specific information from the customer intimacy profile to generate the CSO. However, it is possible that in some cases such data may be absent from the customer intimacy profile. Accordingly, in such embodiments, the AS 214 can be configured to cause the SMMG module 222 to access the appropriate social media channel and retrieve the user data prior to generating the CSO.

In some cases, it is possible that the absent data requires the user to provide additional information to identify the location of the user data needed or requires the user to allow the ECC system 208 to access the user data needed. Accordingly, the user can be prompted for such information. For example, the user can be prompted for a password to a social media channel or a location of a social media channel. In some embodiments, the user can be prompted for such information prior to the CSO being provided. In other embodiments, the CSO can be generated and delivered to the user, where the CSO is configured to prompt the user for the information for accessing the absent user data. In some embodiments, where privacy is a concern, the user can be provided with a prompt that allows the user to supply the user data needed for completing the CSO. Alternatively, encryption or other techniques for securing the information provided by users can be utilized in the various embodiments.

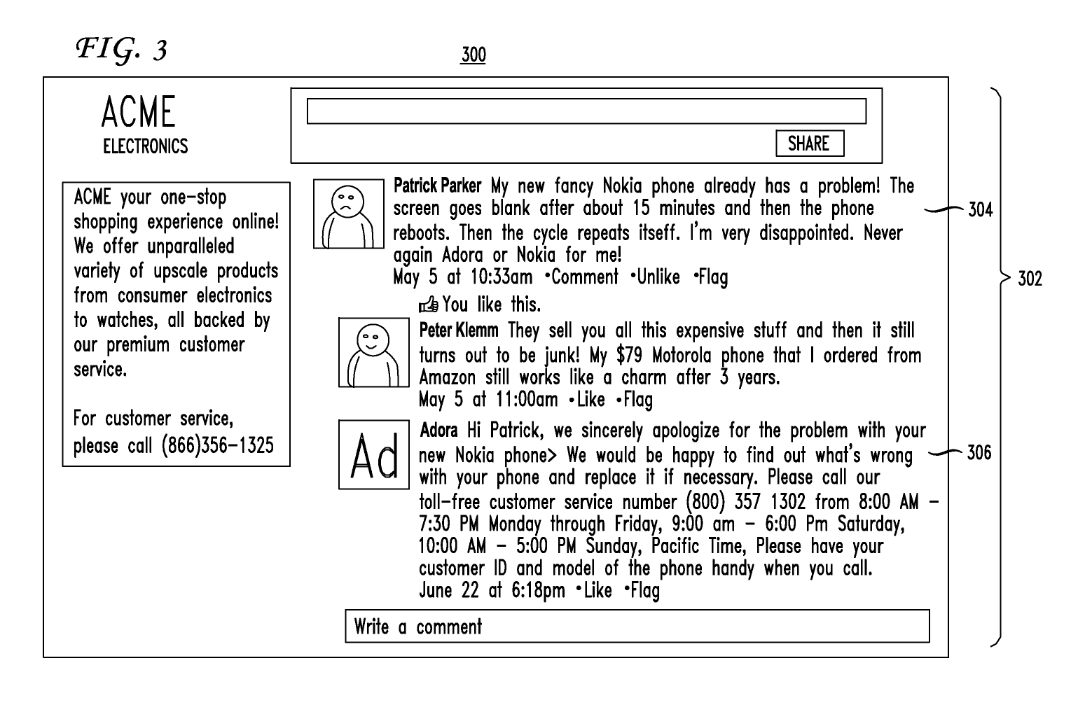

In the various embodiments, the form and function of the CSO can vary depending on the applicable rules. That is, the CSO can be used to support a user interface or can provide the user interface itself For example, the CSO can be embodied as a response engine, such as a customized interactive voice response (IVR) system that is deployed to guide the user to an agent during a telephone call or as an automatic response system for responding to user messages on electronic message boards (EMB). However, in other embodiments, the CSO can provide the user interface presented to the user. Operation of such different types of CSOs is described below in greater detail with respect to FIGS. 3, 4, and 5.

Although the various embodiments will be described below with respect to graphical user interfaces in direct social media channels, this is solely for ease of illustration. Rather the various embodiments described below are equally applicable to any other type of user interface.

FIG. 3 illustrates an exemplary interface 300 for a direct social media channel associated with an enterprise, where the CSO operates in the background as a customized response engine within ECC system 208. As shown in FIG. 3, the interface 300 can include an electronic message board (EMB) 302 for users to provide posts or messages 304 regarding a product of the enterprise. In such a configuration, the ECC system 208, can be configured to monitor the EMB 302, in a manual or automated fashion. Thus, if a question or issue is detected, indicative of the user's desire to interact with an agent, the ECC system 208 can provide a post or message 306 providing instructions to the user on how to contact an agent of the enterprise.

In conventional systems, a response message would typically include either a general customer service phone number or perhaps even a phone number for a specific group of agents associated with a family of products. However, in the various embodiments, after the user question is detected, a CSO is generated using the customer intimacy profile of the user to provide the response message. As a result, the CSO would provide a response message including information for connecting users to agents more particularly suited not just for responding to the question, but customized for responding to the user. For example, if the customer intimacy profile identifies a particular language, expertise level, other products owned by the user, occupation, etc., the contact information provided in response message 306 can be tailored to these characteristics of the user. Thus, a user can be routed to an agent that is more likely to have been trained or have experience with the user's issue and his circumstances. Further, a user can be routed to an agent how is more likely to engage with the user on a more personalized level, thus enhancing the customer service experience.

As described above, the type of information provided to users can vary depending on the customer intimacy profile. For example, a user associated with purchasing of a large number of products of the enterprise may be considered a more “valuable” customer to the enterprise that users purchasing fewer products. Accordingly, a CSO assembled for such valuable users can be configured to provide information to allow such valuable users to reach agents more quickly or more conveniently. That is, valuable users may be offered contact options with lower queue times, extended service hours, or greater amounts of expertise. Further, valuable users can be offered contact options not available to other users. In some cases, the CSO can be configured to tailor the messages to indicate the enhanced status of the user. However, the various embodiments are not limited in this regard the classification of users and the type of information provided to users can vary based on any other criteria.

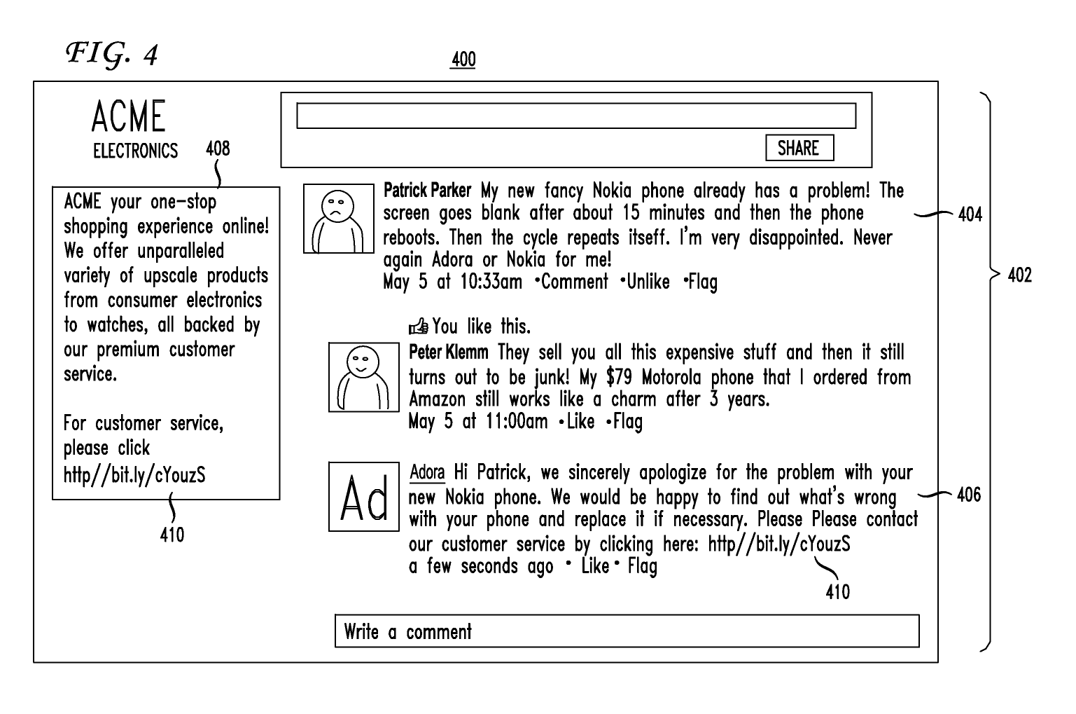

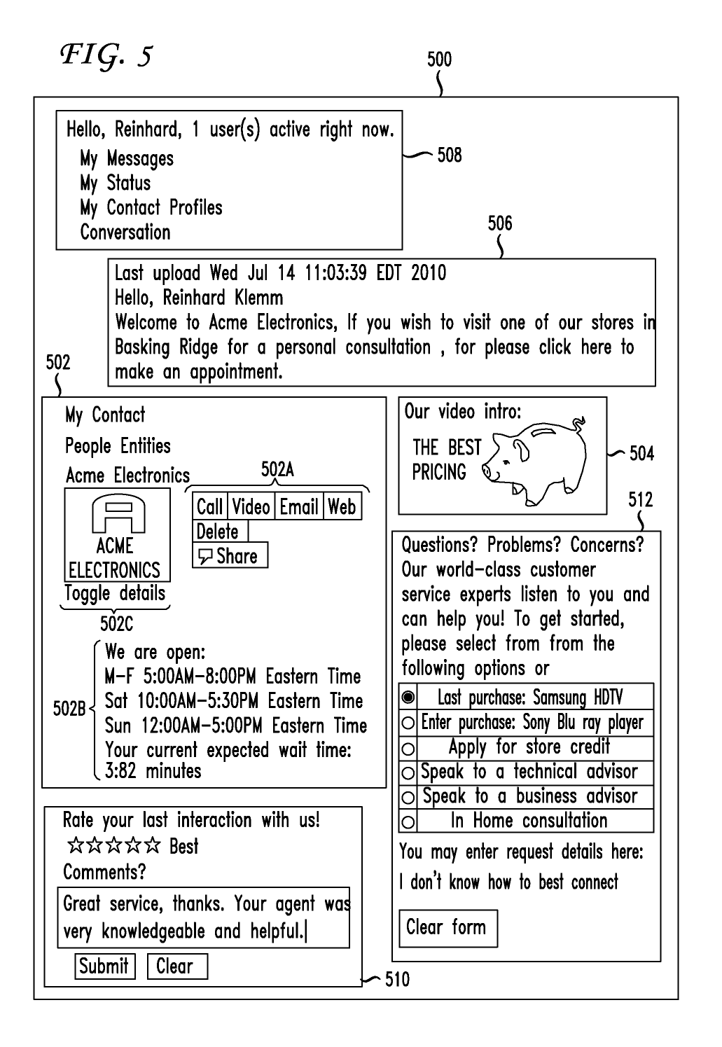

As described above, the CSO can also be delivered to the user terminal 202. That is, the CSO can be provided as a graphical user interface (GUI) for user terminal 202. In such a configuration, the CSO can be further customized to provide users with not only customized contact information, but with additional information that is likely of interest to the users. This is illustrated with respect to FIGS. 4 and 5.

FIG. 4 illustrates a second exemplary interface 400 for a direct social media channel associated with an enterprise. Similar to interface 300 in FIG. 3, a user can utilize the interface 400 to interact with other users and the enterprise, as described above with respect to FIG. 3. Thus, interface 400 can also include an EMB 402, where user messages 404 and responses 406 are posted. However, in addition to such interactions, the interface 400 can provide means for launching a GUI-based CSO. For example, as shown in FIG. 4, the interface 400 can provide an information area 408 including a hyperlink 410 or other type of resource identifier configured to cause the generation, locating, and/or launching a GUI-based CSO. Alternatively, the hyperlink 410 can be included in any other portion of interface 400, including any response messages 406 posted by the enterprise, as shown in FIG. 4.

Responsive to selection of the hyperlink 410, the GUI-based CSO can be launched at a user terminal 202. Additionally, prior to launching the CSO, the selection of hyperlink 410 can cause the ECC system 208 to access user information and generate the CSO, as described above.

FIG. 5 shows an exemplary GUI-based CSO 500. In the various embodiments, the CSO 500 can include a contact element 502 for displaying customer service contact information. Such customer service contact information can be customized, as described above with respect to FIG. 3. However, element 502 can be configured to display various types of information. For example, as shown in FIG. 5, the contact element 502, can include contact options 502A (e.g., telephone, video chat, email, EMBs, text chat, etc.), customer service center information 502B (e.g., location, hours of operation, estimated wait times, etc.), and enterprise information 502C (e.g., general and/or detail company information or background).

In the various embodiments, the contact options 502A can be used by the user to initiate contact with an agent. That is, selection of one of the contact options 502A sends a signal to ECC 208 from user terminal 202, which in turn causes the user terminal 202 to be connected with a one of agent terminals 212. Although FIG. 5 shows a large number of contact options 502A, in the various embodiments the number of contact options 502A can vary from user to user. That is, one or more of the contact options 502A can be unavailable for particular users based on their customer intimacy profile. Alternatively, additional contact options can be available for particular users, based on their customer intimacy profile. For example, as described above, additional communications channels can be made available for more valuable users in order to provide a higher level of service.

The customer service information 502B can be provided to inform users regarding the level of service they should expect to receive. For example, as shown in FIG. 5, the customer service information 502B can indicate operating hours and estimated wait times. Other information can also be provided. In the various embodiments, the customer service information 502B in the CSO 500 is customized for different users based on an associated customer intimacy profile. For example, as described above, valuable users can receive higher levels of service. Thus, the customer service information 502B can be adjusted to reflect the different levels of service available for various users. Thus, the operating hours and estimated wait times presented to different users can be different depending on the level of service associated with the user.

In addition to contact element 502, the CSO 500 can be configured to display additional elements. In the various embodiments, the content of these elements can be selected based at least on the customer intimacy profiles. For example, as shown in FIG. 5, the CSO 500 can be configured to display advertisement elements 504, message elements 506, and user information elements 508. The advertisement elements 504 can be configured to present advertisements of likely interest to the user. The message elements 506 can include messages from the enterprise or elsewhere. In addition, the message elements 506 can be used to display or provide additional contact options for the user. The user information elements 508 can be used to display a current status of the user with respect to one or more network elements, past interaction history for user, messages waiting to be read, and update user information. However, the various embodiments are not limited in this regard and the user information element 508 can be used to provide, identify, or update any other type of information associated with the user.

Additionally, the CSO 500 can also include interactive elements. That is, elements for providing information to the enterprise or other entities. For example, CSO 500 includes a comment element 510 for rating and submitting comments regarding the enterprise, products previously purchased, prior agent interactions, or any other aspects of the enterprise.

In some cases, the CSO 500 can be launched by a user without the identification of a particular issue with a product. For example, referring back to FIG. 4, the CSO can be launched using the hyperlink 410 without requiring the user to post a message. In another example, a user may post a message indicating a question, but that provides only limited information regarding the user's issue. In such cases, the CSO 500 can be configured to improve the customer service experience for the user. In particular, CSO 500 can include a service selection element 510, as shown in FIG. 5. The service selection element 510 can be configured to allow the user to input information regarding the product for which they are seeking service. In some embodiments, as shown in FIG. 5, the CSO can be configured to include radio buttons for selecting the product or type of service being sought. In the various embodiments, check boxes, combo boxes, drop-down lists, list boxes, radio buttons, or any other type of selection GUI object can be used without limitation. As shown in FIG. 5, the selections available to the user need not be limited to products purchased, but can also types of interactions with the enterprise, such as general technical support, credit applications, scheduling of service calls, or consulting services, to name a few. However, the disclosure is not limited in this regard and other selection options can be provided. For example, selection of particular agents or groups of agents, selection of service language, or any other type of options for providing service.

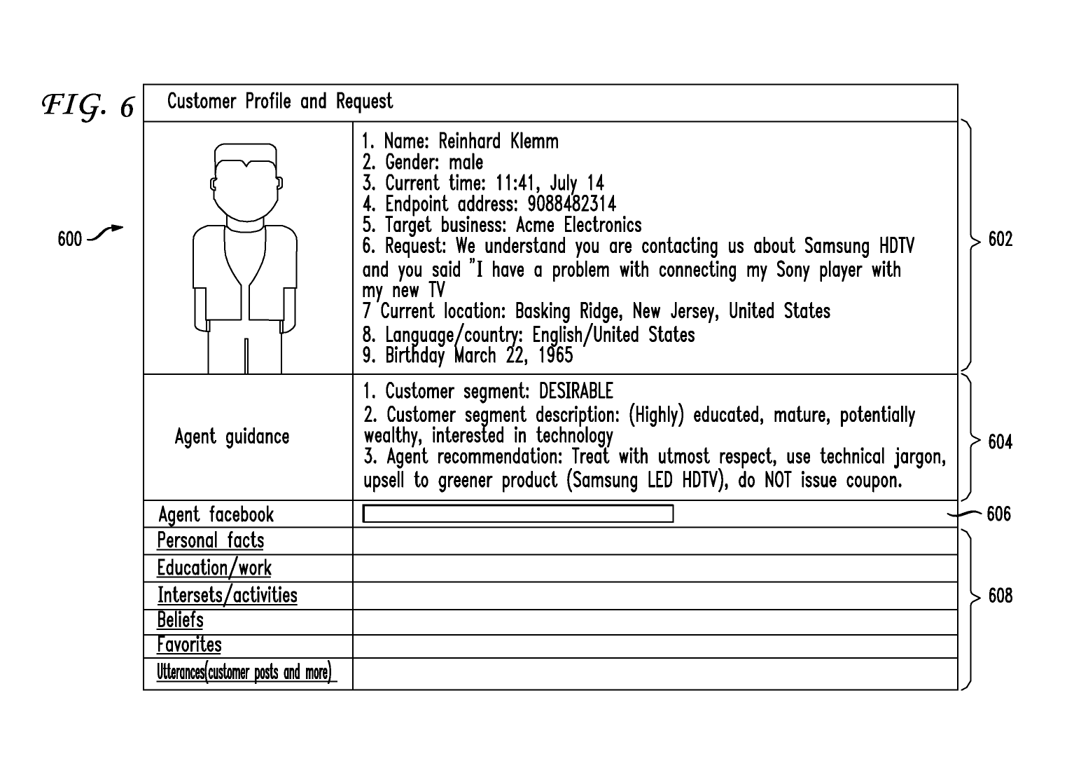

In some embodiments, in addition to generating a CSO for the user, a CSO can also be generated for the agent to be connected with the user. That is, in addition to providing information to the agent regarding the user's issue, one or more portions of the customer intimacy profile can also be forwarded to the agent terminal 212 to allow the agent to engage with the user on a more personalized level. This is illustrated with respect to FIG. 6. FIG. 6 shows and exemplary GUI-based CSO 600 for an agent of an enterprise. The agent CSO 600 can be generated in a similar fashion as the user CSO, using the customer intimacy profile, rules for rules database 226 or elsewhere, and interface elements from interface module database 218.

In the various embodiments, the agent CSO 600 can include a biography element 602. The biography element 602 can include basic information regarding the user, such a name, gender, location, local time, affiliated businesses, language, and issue, to name a few. However, the various embodiments are not limited in this regard and other types of biographical information for identifying the user can also be provided.

In addition to biography element 602, the agent CSO 600 can also include a guidance element 604. The guidance element 604 can include, for example, guidance for interacting with the user. This can include guidance with respect to presenting information to the user, relative importance of the user to the enterprise, cross-selling or up-selling of products, and allowable actions with respect to the user. Additionally, the guidance can indicate whether there are any particular issues, idiosyncrasies, mannerism, idioms, or other characteristics of the user that the agent should be aware of. However, the various embodiments are not limited in this regard and other types of guidance can also be provided without limitation. The guidance can be based on the rules in rules DB 226 and the information in the customer intimacy profile.

The agent CSO 600 can also include a feedback element 606. In some embodiments, the feedback element 606 can be configured for exchanging information with a user terminal 202. In other embodiments, the feedback element 606 can be configured for updating the customer intimacy profile by allowing the agent to submit additional information obtained during his interaction with the user. In the various embodiments, the feedback element can be in the form of an input element, such as a selection element (as described above) or a direct input element, such as a text entry box or other direct input element.

The agent CSO 600 can also be configured to include additional information elements 608. For example, as shown in FIG. 6, the additional information elements 608 can indicate additional characteristics of the user, such as personal facts, schooling, hobbies, and beliefs, to name a few. As a result, the agent can use such information to relate to the user and improve the overall customer service experience.

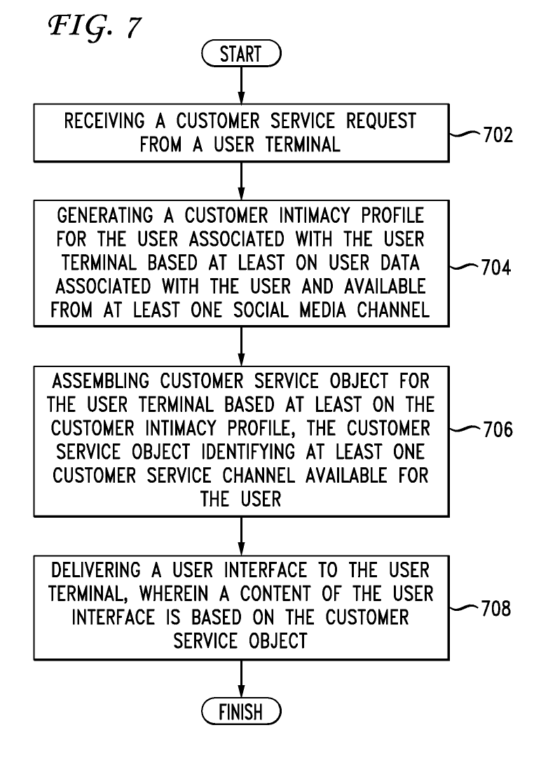

Having disclosed and discussed some exemplary user interfaces and principles, the disclosure turns now to the exemplary method embodiment for providing customized customer service interactions between users and an enterprise as shown in FIG. 7. The method is discussed in terms of a system, such as the computing device of FIG. 1, configured to practice the method. The system 100 receives a customer service request from a user terminal (702) and generates a customer intimacy profile for the user associated with the user terminal based at least on user data associated with the user and available from at least one social media channel (704).

The system 100 assembles customer service object for the user terminal based at least on the customer intimacy profile, the customer service object identifying at least one customer service channel available for the user (706). The system can assemble the customer service object by selecting the at least one customer service channel for the customer service object based on channel selection rules. Then the system 100 delivers a user interface to the user terminal, wherein a content of the user interface is based on the customer service object (708). The system can deliver the user interface by selecting visual characteristics of the user interface based on the customer intimacy profile. Selecting the user interface can include an enterprise contact element, an advertising element, a message element, a service selection element, a feedback element, and/or a user status element.

The system 100 can optionally assemble an agent user interface for an agent of the enterprise responsive to selection of an available customer service channel at the user terminal, the agent interface based at least on the customer intimacy profile. Then the system 100 can establish a communications link between the agent terminal and the user over the available customer service channel. In another variation, the system 100 can identify additional user data required for at least one of the customer intimacy profile and the customer service object, and deliver a request to the user terminal to provide access the additional user data.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of providing customized customer service interactions between users and an enterprise, the method comprising:
receiving a customer service request from a user terminal;
generating a customer intimacy profile for the user associated with the user terminal based at least on user data associated with the user and available from at least one social media channel;
assembling customer service object for the user terminal based at least on the customer intimacy profile, the customer service object identifying at least one customer service channel available for the user; and
delivering a user interface to the user terminal, wherein a content of the user interface is based on the customer service object.

2. The method of claim 1, wherein assembling the customer service object further comprises selecting the at least one customer service channel for the customer service object based on channel selection rules.

3. The method of claim 1, wherein delivering the user interface further comprises selecting visual characteristics of the user interface based on the customer intimacy profile.

4. The method of claim 1, wherein delivering the user interface further comprises selecting the user interface to comprise at least one of an enterprise contact element, an advertising element, a message element, a service selection element, a feedback element, and a user status element.

5. The method of claim 1, further comprising:
responsive to selection of an available customer service channel at the user terminal, assembling an agent user interface for an agent of the enterprise, the agent interface based at least on the customer intimacy profile; and
establishing a communications link between the agent terminal and the user over the available customer service channel.

6. The method of claim 1, further comprising:
identifying additional user data required for at least one of the customer intimacy profile and the customer service object; and
delivering a request to the user terminal to provide access the additional user data.

7. The method of claim 1, wherein delivering the user interface further comprises selecting the customer service object as the user interface.

8. A system for providing customized customer service interactions between users and an enterprise, the system comprising:
a processor;
a first module for causing the processor to generate a customer intimacy profile for a user associated with a user terminal based at least on user data associated with the user and available from at least one social media channel;
a second module for causing the processor to assemble a customer service object for the user terminal based at least on the customer intimacy profile, the customer service object identifying at least one customer service channel available for the user; and
a third module for causing the processor to deliver a user interface to the user terminal, wherein a content of the user interface is based on the customer service object.

9. The system of claim 8, wherein the second module is further configured to cause the processor to select the at least one customer service channel for the customer service object based on channel selection rules.

10. The system of claim 8, wherein the third module is further configured to cause the processor to select visual characteristics of the user interface based on the customer intimacy profile.

11. The system of claim 8, wherein the third module is further configured to cause the processor to include in the user interface at least one of an enterprise contact element, an advertising element, a message element, a service selection element, a feedback element, and a user status element.

12. The system of claim 8, further comprising:
a fourth module for causing the processor to assemble an agent user interface for an agent of the enterprise responsive to a selection of an available customer service channel at the user terminal, the agent interface based at least on the customer intimacy profile; and
a fifth module for causing the processor to establish a communications link between the agent terminal and the user over the available customer service channel.

13. The method of claim 8, further comprising:
a fourth module for causing the processor to identify additional user data required for at least one of the customer intimacy profile and the customer service object; and
a fifth module for causing the processor to deliver a request to the user terminal to provide access the additional user data.

14. The method of claim 8, wherein the third module is further configured for selecting the customer service object as the user interface.

15. A non-transitory computer-readable storage medium storing instructions which, when executed by a computing device, cause the computing device to provide customized customer service interactions between users and an enterprise, the instructions comprising:
receiving a customer service request from a user terminal;
generating a customer intimacy profile for the user associated with the user terminal based at least on user data associated with the user and available from at least one social media channel;
assembling customer service object for the user terminal based at least on the customer intimacy profile, the customer service object identifying at least one customer service channel available for the user; and
delivering a user interface to the user terminal, wherein a content of the user interface is based on the customer service object.

16. The non-transitory computer-readable storage medium of claim 15, wherein assembling the customer service object further comprises selecting the at least one customer service channel for the customer service object based on channel selection rules.

17. The non-transitory computer-readable storage medium of claim 15, wherein delivering the user interface further comprises selecting visual characteristics of the user interface based on the customer intimacy profile.

18. The non-transitory computer-readable storage medium of claim 15, wherein delivering the user interface further comprises selecting the user interface to comprise at least one of an enterprise contact element, an advertising element, a message element, a service selection element, a feedback element, and a user status element.

19. The non-transitory computer-readable storage medium of claim 15, the instructions further comprising:
assembling an agent user interface for an agent of the enterprise responsive to selection of an available customer service channel at the user terminal, the agent interface based at least on the customer intimacy profile; and
establishing a communications link between the agent terminal and the user over the available customer service channel.

20. The non-transitory computer-readable storage medium of claim 15, the instructions further comprising:
identifying additional user data required for at least one of the customer intimacy profile and the customer service object; and
delivering a request to the user terminal to provide access the additional user data.
